(19) United States
(12) Patent Application Publication
(10) Pub. No.: US 2023/0101658 A1
(43) Pub. Date: Mar. 30, 2023

(54) DURESS-BASED USER ACCOUNT DATA PROTECTION

(71) Applicant: Lenovo (United States) Inc., Morrisville, NC (US)

(72) Inventor: David Rivera, Raleigh, NC (US)

(21) Appl. No.: 17/490,534

(22) Filed: Sep. 30, 2021

(51) Int. Cl. G06F 21/31; G06F 21/55; G06K 9/00

(52) U.S. Cl. CPC G06F 21/316; G06F 21/554; G06K 9/0063; G06K 9/00302; G06K 9/00201

(57) ABSTRACT

One embodiment provides a method, including: receiving, at an information handling device, a login request to a user account; identifying, using a processor, that the login request was provided by an authorized user; determining, subsequent to the identifying, whether the authorized user provided the login request under duress; and performing, responsive to determining that the authorized user provided the login request under duress, an action that protects one or more data sources contained within the user account. Other aspects are described and claimed.

### BACKGROUND

Individuals may interact with a variety of different types of information handling devices (“devices”), for example smart phones, tablets, wearable devices, laptop and/or personal computers, hybrid devices, and the like, throughout the day. These devices may contain one or more user accounts or profiles in which individuals may store various types of data (e.g., personal information, sensitive work-product, financial information, etc.). User accounts generally contain various protections that must be overcome (e.g., by the provision of a correct passcode, etc.) in order to obtain access to the information stored within.

### BRIEF SUMMARY

In summary, one aspect provides a method, including: receiving, at an information handling device, a login request from to a user account; identifying that the login request was provided by an authorized user; determining, using a processor, whether the authorized user provided the login request under duress; and performing, responsive to determining that the authorized user provided the login request under duress, an action that protects one or more data sources contained within the user account.

Another aspect provides an information handling device, including: a processor; a memory device that stores instructions executable by the processor to: receive a login request a user account; identify that the login request was provided by an authorized user; determine whether the authorized user provided the login request under duress; and perform, responsive to determining that the authorized user provided the login request under duress, an action that protects one or more data sources contained within the user account.

A further aspect provides a product, including: a storage device that stores code, the code being executable by a processor and comprising: code that receives a login request to a user account; code that identifies that the login request was provided by an authorized user; code that determines whether the authorized user provided the login request under duress; and code that performs, responsive to determining that the authorized user provided the login request under duress, an action that protects one or more data sources contained within the user account.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of performing an action that protects one or more data sources within a user account.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As computing devices have become prevalent in our daily lives, users have a greater interest than ever before in ensuring that the information accessible on these devices is protected. Various solutions exist today for protecting data within a user account on a device. For example, one or more conventional security measures may be employed at the point-of-entry to protect the initial access to the user account (e.g., a username and passcode pair, facial feature identification, voice analysis, etc.). Additional measures may be implemented that protect data after a user account has already been accessed. For instance, some computer systems may be able to dynamically obscure displayed content on a display screen responsive to identifying that an unauthorized individual is in proximity to the device or is peering at the display screen (e.g., by activating an electronic privacy filter, by dimming the display screen, by deactivating the display screen, etc.).

All of the foregoing security measures, however, are not without their faults. For instance, point-of-entry security measures may be overcome by bad actors who are able to effectively trick the computing system into thinking that the authorized user is attempting to access the device (e.g., by placing an image of an authorized user in front of a computer's camera or by employing one or more other spoofing techniques known in the art, etc.). Although various anti-spoofing techniques exist that ensure that an authorized user is really the one accessing a user account rather than a bad actor or a non-person entity, these techniques generally only rely on human presence detection and/or identification and do not attempt to identify an intent of the access-requesting individual (i.e., whether or not the access-requesting individual is under duress and/or actually wants to access the information in the account). Furthermore, although the post-access security measures may provide protection for displayed content, they do not offer additional protections for entry into a user account.

Accordingly, an embodiment provides a method for performing an action that protects data in a user account. In an embodiment, a login request to a user account may initially be received at a device. An embodiment may then be able to identify that the login request was provided by an authorized user (e.g., using one or more authorized user determination techniques, etc.) and may thereafter determine whether the authorized user provided the login request under duress. Responsive to determining that the authorized user did provide the login request under duress, an embodiment may execute an action that protects data accessible through the user account (e.g., preventing access to the user account, automatically notifying an account administrator or other authority, initiating a “dummy” account, etc.). Such a method may ensure that a user account can only be accessed by an authorized user that truly wants to gain access to the information stored within the account.

The illustrated example embodiments will be best understood by reference to the figures. The following description is intended only by way of example, and simply illustrates certain example embodiments.

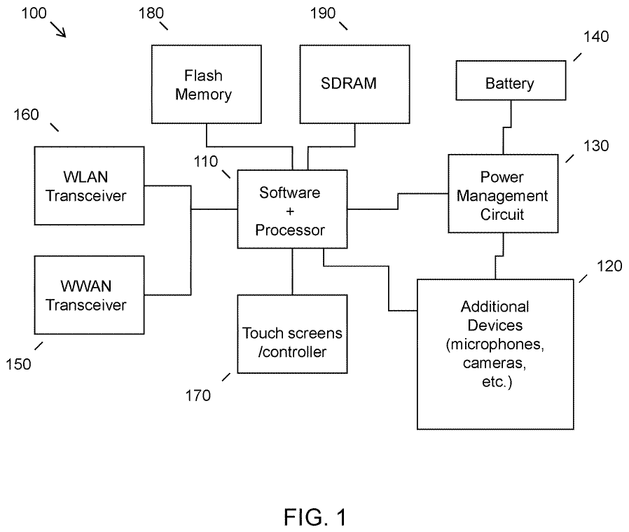

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

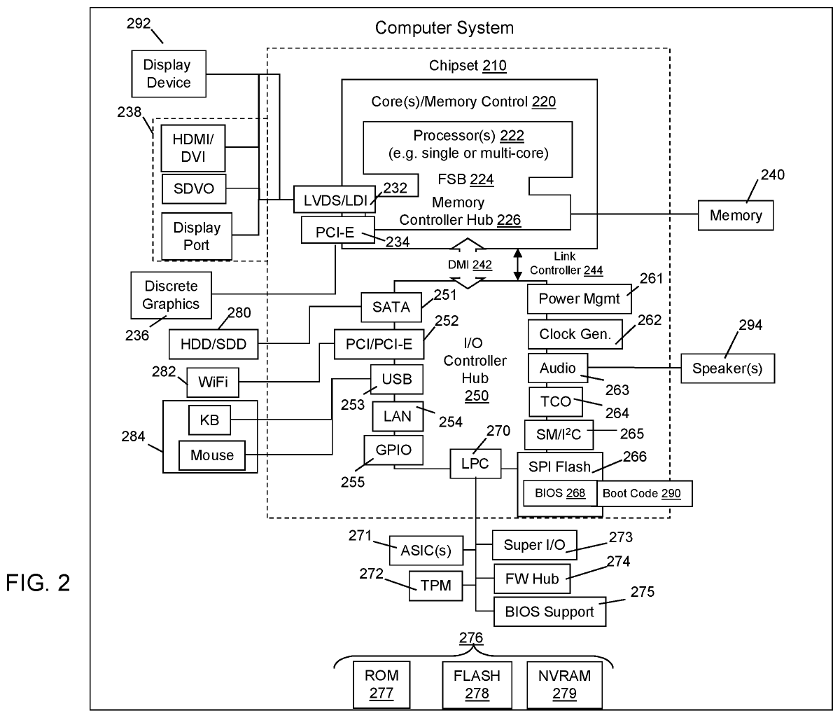

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling circuitry, as for example outlined in FIG. 1 or FIG. 2, may be used in devices that are capable of identifying various characteristics associated with an access-requesting user. For example, the circuitry outlined in FIG. 1 may be implemented in a smart phone, whereas the circuitry outlined in FIG. 2 may be implemented in a laptop or personal computer.

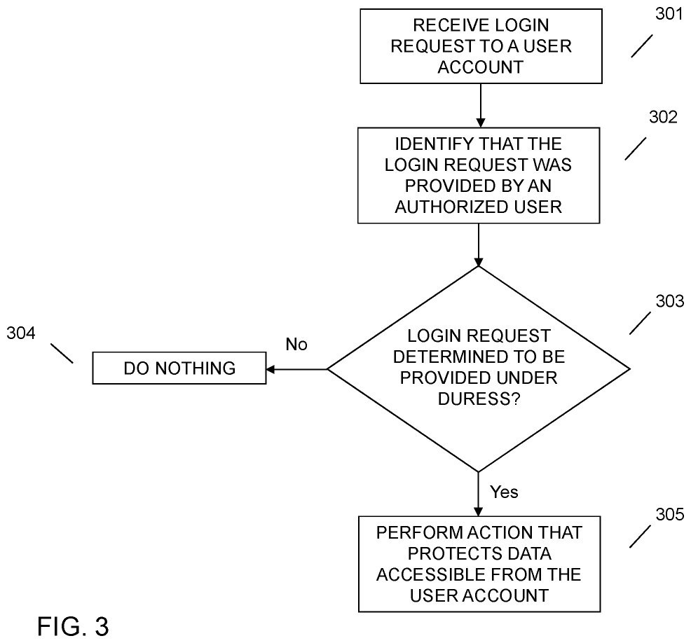

Referring now to FIG. 3, an embodiment provides a method of performing an action that can protect data accessible from a user account. At 301, an embodiment may receive a login request to a user account. In the context of this application, the user account may correspond to one or both of: a system-based account (i.e., a top-level account that a user must gain access to in order to effectively utilize the device) or a user profile contained within a particular application (e.g., a banking application, an email application, etc.) or a web-based site. In an embodiment, the login request may take one or more different forms and may be detected by the device using one or more relevant means. Non-limiting examples of login request detection include: detection of a typed passcode into an input field of a user account login screen, detection of an audible pass phrase directed toward the device via an audio capture device (e.g., a microphone, etc.), detection of a specific gesture input or gesture input sequence via a camera, etc.

At 302, an embodiment may identify that the login request was provided by an authorized user. This identification may be facilitated using one, or a combination of, authorized user identification techniques. For example, an embodiment may determine that an authorized user has provided the login request by simply identifying that a received passcode was a correct passcode to obtain access to the user account. As another example, an embodiment may utilize data obtained from one or more sensors integrally or operatively coupled to the device (e.g., a camera sensor, a microphone, etc.) to facilitate the identification. For instance, an embodiment may capture an image of a user and compare aspects of the captured image (e.g., user facial features, etc.) to a stored image of authorized user to determine the level of similarity between the two. In a similar instance, an embodiment may capture an audio segment provided by the user and compare the captured audio to a stored voice profile of an authorized user to determine if they share a predetermined level of similarity. It is important to note that the foregoing authorized user identification techniques are non-limiting and that other techniques known in the art, not explicitly described here, may also be utilized alone or in combination with the foregoing.

At 303, an embodiment may determine whether the authorized user provided the login request under a duress situation. In the context of this application, a duress situation may be defined as one in which the authorized user provided the login request against their will because they were under threat of violence or other manipulation. The following determination techniques may be used alone or in combination to determine whether aspects associated with a duress situation were present when the login request was received.

In an embodiment, the determination of a duress situation may be facilitated by simply identifying that another individual is proximate to the authorized user when the login request is received. An embodiment may conduct this determination by first capturing an image (e.g., a static image such as a picture, a dynamic image such as a video, etc.) of an area associated with the authorized user (e.g., by using a front-facing camera on the user's device, etc.). An embodiment may then utilize one or more image analysis techniques known in the art to analyze the image to identify if any other individuals are in proximity to the user (e.g., standing next to the user, standing behind the user, etc.). Responsive to identifying that at least one other individual is present, an embodiment may conclude that the user is under duress.

In an embodiment, the determination of a duress situation may be facilitated by identifying whether one or more specific types of objects are proximate to or oriented toward the authorized user in a threatening way. The relevant objects monitored for herein are known weapons (e.g., knives, guns, etc.) or other common objects that are utilized as weapons (e.g., a baseball bat, a hammer, etc.). An embodiment may conduct this determination by first capturing an image of the authorized user and then utilizing one or more image analysis techniques known in the art to analyze the image and identify any objects presents therein. An embodiment may then access a database (e.g., stored locally on the device, stored remotely on another device or server, etc.) comprising a list of known weapons and common objects utilized as weapons that the identified objects in the image may be compared to. Responsive to identifying that a match exists (e.g., by determining that an identified object in an image shares a predetermined level of similarity with an object in the list, etc.) an embodiment may determine that the authorized user provided the login request under duress.

In an embodiment, the determination of a duress situation may be facilitated by identifying whether one or more facial expressions indicative of duress are expressed by the authorized user. An embodiment may conduct this determination by first capturing an image of the authorized user and then utilizing one or more image analysis techniques known in the art to analyze the image to identify a user's facial expressions. An embodiment may then access a database comprising a list of known facial expressions of individuals under duress (e.g., relevant facial expressions may include a pale face, wide eyes, raised eyebrows, an open mouth, presence of tears, and other facial expressions not explicitly described here but that are known to be expressed by individuals under duress, etc.) that the identified facial expressions of the authorized user may be compared to. Responsive to identifying that a match exists (e.g., by determining that the identified facial expression of the authorized user shares a predetermined level of similarity with one or more stored facial expressions in the list, etc.) an embodiment may determine that the authorized user provided the login request under duress.

In an embodiment, the determination of a duress situation may be facilitated by identifying whether one or more audible cues indicative of duress are expressed by the authorized user. An embodiment may conduct this determination by first capturing (e.g., using a microphone, etc.) an audio segment of sounds present in the area of the authorized user and thereafter analyzing the audio segment by utilizing one or more audio analysis techniques known in the art. An embodiment may then access a database comprising a list of known sounds associated with individuals under duress (e.g., crying, screaming, rapid speaking, other sounds not explicitly described here but that are known to be expressed by individuals under duress, etc.) that the identified sounds in the audio segment may be compared to. Responsive to identifying that a match exists (e.g., by determining that the identified sounds in the audio segment share a predetermined level of similarity with one or more stored sounds in the list, etc.) an embodiment may determine that the authorized user provided the login request under duress.

In an embodiment, the determination of a duress situation may be facilitated by identifying that the authorized user has provided a secret, “duress” passcode into an input field. Receipt of this duress passcode may provide an explicit indication to the system that the user is under duress and that it should perform one or more of the actions described below. It is important to note that although the foregoing was described with respect to input of a passcode, such an implementation is not limiting and the same concept may be applicable to other input methodologies (e.g., input of a secret duress pass-phrase, input of a secret duress pass-gesture, etc.).

Responsive to determining, at 303, that an authorized user did not enter the login request under duress, an embodiment may, at 304, take no additional action. Conversely, responsive to determining, at 303, that an authorized user was under duress when they provided the login request, an embodiment may, at 305, perform an action that protects data accessible from the user account. In an embodiment, the performance of this action may occur automatically and without receipt of any additional user input. An embodiment may perform one of the following actions or, alternatively, may perform any combination of the following actions.

In an embodiment, the action may correspond to a locking of the user account. More particularly, an embodiment may prevent access to the user account by the authorized user or any other individual. In an embodiment, access to the user account may be prevented for a predetermined period of time (e.g., 10 minutes, 1 hour, 1 day, etc.) or until a predetermined event has been identified (e.g., the user account may be locked until it is determined that the authorized user is no longer under duress, until a designated “safe” password is received in the input field, etc.).

In an embodiment, the action may correspond to a notification that may be provided to one or more designated recipients. In an embodiment, the designated recipients may be one or more individuals or entities that the authorized user has previously designated as targets to receive the notification. For example, the designated recipients may one or more of: friends, family members, account administrators/mangers, law enforcement personnel, etc. In an embodiment, the notification may be an audio and/or visual notification that may inform the recipient that the authorized user provided a login request under duress. Additionally or alternatively, the notification may contain additional information such as the physical location that the login request was provided and/or various types of captured data that were utilized in the previously described determination process (e.g., images of the authorized user under duress including any images of proximate objects or individuals, audio segments of the authorized user under duress, etc.) In an embodiment, the notification may be provided to the designated recipients a predetermined number of times (e.g., once, 5 times, 10 times, etc.) or may be provided continuously at predetermined intervals (e.g., every hour, etc.) until a predetermined event has been identified (e.g., a notification may continue to be provided until the authorized user is determined to no longer be under duress, etc.).

In an embodiment, the action may correspond to the dynamic initiation of an imitation account. In the context of this application, an imitation account may be a “dummy” account that is automatically loaded in response to the login request and that is similar in appearance to the authentic user account but that contains one or more aspects that are substantially non-functional. For example, an imitation user account may allow an individual to access and interact with various non-sensitive aspects of the account (e.g., a user on the imitation account may surf the web, check sports scores, stream media, etc.) but may be prevented from performing one or more sensitive tasks (e.g., initiating a financial transaction, accessing certain files, adjusting user settings, etc.). In an embodiment, the aspects of the imitation account designated to be non-functional may simply be prevented from initiating (e.g., nothing will happen if a user double-clicks on a banking application icon or otherwise attempts to open the banking application, etc.). Alternatively, in another embodiment, the designated aspects may appear to be active and/or accessible but are not actually performing the desired functions. For example, an individual can interact with a banking application on a user account and work through the steps of transferring finances from one account to the next. Although it may appear to a user that a successful transaction was conducted, no finances were actually transferred.

The various embodiments described herein thus represent a technical improvement to conventional methods for protecting data accessible via a user account. Using the techniques described herein, an embodiment may receive a login request and identify that the login request was provided by an authorized user. An embodiment may then determine whether the authorized user provided the login request while under duress and thereafter perform, responsive to determining that the authorized user did provide the login request under duress, an action to protect the data accessible via the user account. Such a method may provide more security to a user account and ensure that the information accessible via the user account is only accessed if an authorized user truly intends to access it.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device, a login request to a user account;
identifying, using a processor, that the login request was provided by an authorized user;
determining, subsequent to the identifying, whether the authorized user provided the login request under duress; and
performing, responsive to determining that the authorized user provided the login request under duress, an action that protects one or more data sources contained within the user account.

2. The method of claim 1, wherein the determining comprises:
capturing, using a camera, an image of a scene containing the authorized user;
determining, via analysis of the image, whether a duress-producing object is present in the scene; and
identifying that the authorized user is under duress responsive to determining that the duress-producing object is present.

3. The method of claim 2, wherein the duress-producing object is one of: an identifiable weapon or a non-weapon object utilized as a weapon.

4. The method of claim 1, wherein the determining comprises:
capturing, using a camera, an image of the authorized user;
determining, via analysis of the image, whether one or more facial expressions indicative of duress are expressed by the authorized user; and
identifying that the authorized user is under duress responsive to identifying the one or more facial expressions in the image.

5. The method of claim 4, wherein the one or more facial expressions are selected from a group consisting of: a pale face, wide eyes, open mouth, raised eyebrows, and tears.

6. The method of claim 1, wherein the determining comprises:
capturing, using an audio capture device, ambient sound;
determining, via analysis of the ambient sound, whether one or more audible indications of duress are detected from the authorized user in the ambient sound; and
identifying that the authorized user is under duress responsive to identifying that the one or more audible indications are detected.

7. The method of claim 6, wherein the one or more audible indications are selected from the group consisting of: crying, screaming, and rapid speaking.

8. The method of claim 1, wherein the performing the action comprises preventing a login to the user account.

9. The method of claim 1, wherein the performing the action comprises providing a notification to a designated recipient that the authorized user provided the login request under duress.

10. The method of claim 1, wherein the performing the action comprises initiating an imitation account, wherein the imitation account comprises an appearance substantially similar to the user account and wherein the one or more data sources are not accessible from the imitation account.

11. An information handling device, comprising:
a processor;
a memory device that stores instructions executable by the processor to:
receive a login request from to a user account;
identify that the login request was provided by an authorized user;
determine whether the authorized user provided the login request under duress; and
perform, responsive to determining that the authorized user provided the login request under duress, an action that protects one or more data sources contained within the user account.

12. The information handling device of claim 11, wherein the instructions executable by the processor to determine comprise instructions executable by the processor to:
capture, using a camera, an image of a scene containing the authorized user;
determine, via analysis of the image, whether a duress-producing object is present in the scene, wherein the duress-producing object is one of: an identifiable weapon or a harm-producing object; and
identify that the authorized user is under duress responsive to determining that the duress-producing object is present.

13. The information handling device of claim 11, wherein the instructions executable by the processor to determine comprise instructions executable by the processor to:
capture, using a camera, an image of the authorized user;
determine, via analysis of the image, whether one or more facial expressions indicative of duress are expressed by the authorized user; and
identify that the authorized user is under duress responsive to identifying the one or more facial expressions in the image.

14. The information handling device of claim 13, wherein the one or more facial expressions are selected from a group consisting of: a pale face, wide eyes, open mouth, raised eyebrows, and tears.

15. The information handling device of claim 11, wherein the instructions executable by the processor to determine comprise instructions executable by the processor to:
capture, using an audio capture device, ambient sound;
determine, via analysis of the ambient sound, whether one or more audible indications of duress are detected from the authorized user in the ambient sound; and
identify that the authorized user is under duress responsive to identifying that the one or more audible indications are detected.

16. The information handling device of claim 15, wherein the one or more audible indications are selected from the group consisting of: crying, screaming, and rapid speaking.

17. The information handling device of claim 11, wherein the instructions executable by the processor to perform the action comprise instructions executable by the processor to prevent a login to the user account.

18. The information handling device of claim 11, wherein the instructions executable by the processor to perform the action comprise instructions executable by the processor to provide a notification to a designated recipient that the authorized user provided the login request under duress.

19. The information handling device of claim 11, wherein the instructions executable by the processor to perform the action comprise instructions executable by the processor to initiate an imitation account, wherein the imitation account comprises an appearance substantially similar to the user account and wherein the one or more data sources are not accessible from the imitation account.

20. A product, comprising:
a storage device that stores code, the code being executable by a processor and comprising:
code that receives a login request to a user account;
code that identifies that the login request was provided by an authorized user code that determines whether the authorized user provided the login request under duress; and
code that performs, responsive to determining that the authorized user provided the login request under duress, an action that protects one or more data sources contained within the user account.
